(19) United States
(12) Patent Application Publication
(10) Pub. No.: US 2023/0147582 A1
(43) Pub. Date: May 11, 2023

(54) STRUCTURE, IMAGE FORMING APPARATUS, METHOD OF PRODUCING STRUCTURE

(71) Applicant: KYOCERA Document Solutions Inc., Osaka-shi, Osaka (JP)

(72) Inventor: Kazuhisa HIRAHARA, Osaka (JP)

(21) Appl. No.: 17/911,995

(22) PCT Filed: Mar. 12, 2021
(86) PCT No.: PCT/JP2021/010145

§ 371 Date: Sep. 15, 2022

(30) Foreign Application Priority Data
Mar. 16, 2020 (JP) 2020-045235

(51) Int. Cl. G03G 21/16

(52) U.S. Cl. CPC G03G 21/1619

(57) ABSTRACT

An object of the present invention is to increase the dimensional accuracy of a structure including a plurality of rectangular pipes. A structure (6) includes a plurality of rectangular pipes (60) joined together. The plurality of rectangular pipes (60) include a first rectangular pipe (60a) and a second rectangular pipe (60b) joined by welding. Two or three of four sides that constitute an end face (62) of the first rectangular pipe (60a) are joint sides (62a) welded to a side face (63) of the second rectangular pipe (60b), whereas the rest of the four sides is a non-joint side (62b) separated from the side face (63) of the second rectangular pipe (60b) by a gap.

### TECHNICAL FIELD

The present invention relates to a structure including a plurality of rectangular pipes joined together, an image forming apparatus including the structure, and a method of producing a structure.

### BACKGROUND ART

An image forming apparatus includes a sheet feed portion, a printing portion, and a developer container. The image forming apparatus further includes a structure that houses and supports the sheet feed portion, the printing portion, and the developer container.

For example, the structure is known to include a plurality of rectangular pipes joined by welding (for example, see PTL 1). The structure with such a configuration has high strength.

### CITATION LIST

### Patent Literature

[PTL 1] Japanese Patent Application Publication No. 2000-138470

### SUMMARY OF THE INVENTION

### Problems to be Solved by the Invention

Usually, each of the rectangular pipes constituting the structure is cut out from a long base pipe to a desired length. In this case, it is difficult to increase the accuracy of the length of each rectangular pipe and the accuracy of the angles of the end faces relative to the side faces.

Accordingly, welding two rectangular pipes together with an end face of one of the pipes in contact with a side face of the other pipe makes it difficult to produce the structure with high dimensional accuracy.

An object of the present invention is to provide a structure including a plurality of rectangular pipes joined by welding and having high dimensional accuracy, an image forming apparatus including the structure, and a method of producing the structure.

### Solution to the Problems

A structure according to an aspect of the present invention includes a plurality of rectangular pipes joined together. The plurality of rectangular pipes include a first rectangular pipe and a second rectangular pipe joined by welding. Two or three of four sides that constitute an end face of the first rectangular pipe are joint sides welded to a side face of the second rectangular pipe, whereas a rest of the four sides is a non-joint side separated from the side face of the second rectangular pipe by a gap.

An image forming apparatus according to another aspect of the present invention includes a sheet feed portion, a printing portion, and the above-described structure. The printing portion forms an image on a sheet supplied from the sheet feed portion. The structure houses and supports the sheet feed portion and the printing portion.

A method of producing a structure according to another aspect of the present invention is a method of producing the structure including a plurality of rectangular pipes joined together. The production method includes positioning a first rectangular pipe and a second rectangular pipe by placing the first rectangular pipe and the second rectangular pipe along a jig for positioning such that four sides constituting an end face of the first rectangular pipe face a side face of the second rectangular pipe with a gap therebetween. The production method further includes welding only some of the four sides that constitute the end face of the first rectangular pipe, the four sides facing the side face of the second rectangular pipe with the gap therebetween, to the side face of the second rectangular pipe.

### Advantageous Effects of the Invention

According to the present invention, a structure including a plurality of rectangular pipes joined by welding and having high dimensional accuracy, an image forming apparatus including the structure, and a method of producing the structure can be provided.

### BRIEF DESCRIPTION OF THE DRAWINGS

FIG. 1 is a configuration diagram of an image forming apparatus including a structure according to an embodiment.

FIG. 2 is a perspective view of the structure according to the embodiment.

FIG. 3 is a perspective view of two rectangular pipes joined together in the structure according to the embodiment.

FIG. 4 is a side view of a joint part in the structure according to the embodiment.

FIG. 5 is a plan view of the joint part in the structure according to the embodiment.

FIG. 6 is a flowchart showing a procedure of a method of producing the structure according to the embodiment.

FIG. 7 shows a step of positioning the rectangular pipes in the method of producing the structure according to the embodiment.

FIG. 8 is a perspective view of two rectangular pipes positioned in the step of positioning the rectangular pipes in the method of producing the structure according to the embodiment.

### DESCRIPTION OF EMBODIMENTS

The following describes an embodiment of the present invention with reference to the accompanying drawings. It should be noted that the following embodiment is an example of a specific embodiment of the present invention and should not limit the technical scope of the present invention.

[Configuration of Image Forming Apparatus 10]

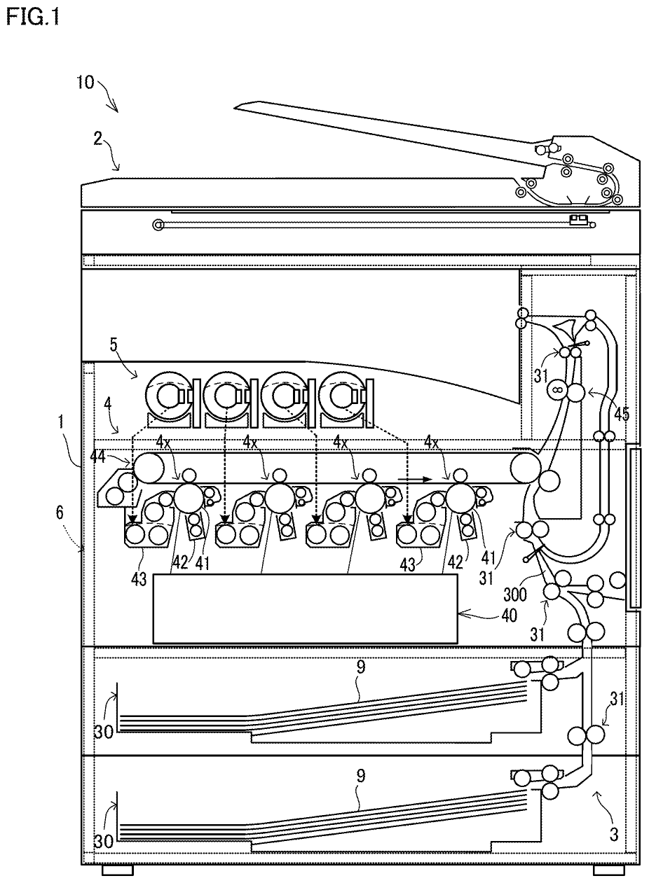

A structure 6 according to an embodiment is adopted by an image forming apparatus 10. As shown in FIG. 1, the image forming apparatus 10 includes a body unit 1 and an image reading unit 2.

The body unit 1 includes sheet feed portions 30, a sheet conveying device 3, a printing portion 4, one or more developer containers 5, and the structure 6. The image reading unit 2 is connected to an upper part of body unit 1. The image reading unit 2 reads the images of document sheets.

The sheet feed portions 30 each house a plurality of sheets and feed the housed sheets one by one to a sheet conveyance path 300. The sheet conveying device 3 includes a plurality of conveying roller pairs 31 that convey the sheets along the sheet conveyance path 300.

The printing portion 4 forms images on the sheets supplied from the sheet feed portions 30 through the sheet conveying device 3. In the example shown in FIG. 1, the printing portion 4 forms images on the sheets by an electrophotographic method.

The electrophotographic printing portion 4 includes a laser scanning unit 40, one or more image creating devices 4x, a transfer device 44, and a fixing device 45.

In the example shown in FIG. 1, the printing portion 4 is a color-image printing device of a tandem type. Accordingly, the printing portion 4 includes four image creating devices 4x that respectively correspond to four colors of toner. Furthermore, the image forming apparatus 10 includes four developer containers 5 that respectively correspond to the four image creating devices 4x.

In each of the image creating devices 4x, a drum-shaped photoconductor 41 rotates, a charging device 42 electrically charges the outer peripheral surface of the photoconductor 41, the laser scanning unit 40 forms an electrostatic latent image on the outer peripheral surface of the photoconductor 41, and a developing device 43 develops the electrostatic latent image as a toner image.

Furthermore, in the transfer device 44, an intermediate transfer belt 440 rotates while being in contact with the four photoconductors 41, four primary transfer devices 441 respectively corresponding to the four image creating devices 4x transfer the toner images to the intermediate transfer belt 440, and a secondary transfer device 442 transfers the toner images on the intermediate transfer belt 440 to the sheets that are being conveyed on the sheet conveyance path 300.

The fixing device 45 fixes the toner images on the sheets to the sheets by heating and pressurizing the toner images. The sheet conveying device 3 discharges the sheets on which images have been formed from the sheet conveyance path 300.

The developer containers 5 supply toner to the corresponding developing devices 43 in the printing portion 4. The toner is an example of developer. The printing portion 4 may form images on the sheets by an inkjet printing method or other methods.

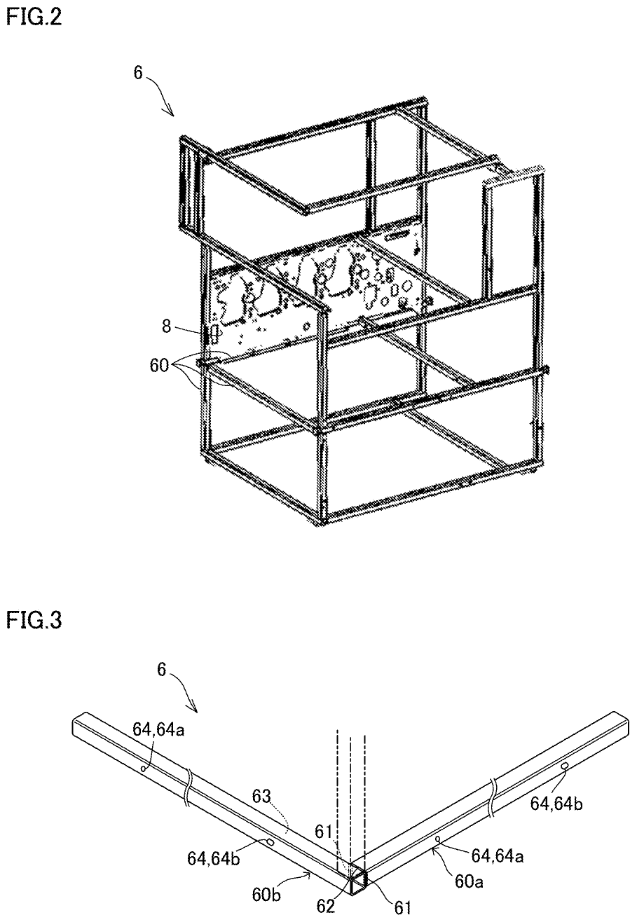

The structure 6 houses and supports the sheet feed portions 30, the sheet conveying device 3, the printing portion 4, and the developer containers 5. The image reading unit 2 is connected to an upper part of structure 6. The structure 6 includes a plurality of rectangular pipes 60 joined by welding (see FIG. 2).

Usually, each of the rectangular pipes 60 constituting the structure 6 is cut out from a long base pipe to a desired length. In this case, it is difficult to increase the accuracy of the length of each rectangular pipe 60 and the accuracy of the angles of the end faces relative to the side faces.

Accordingly, welding two rectangular pipes 60 together with an end face of one of the pipes in contact with a side face of the other pipe makes it difficult to produce the structure 6 with high dimensional accuracy.

However, as described below, the plurality of rectangular pipes 60 constituting the structure 6 are joined such that the structure 6 has high dimensional accuracy as a whole even though the dimensional accuracy of the end faces of each rectangular pipe 60 is not high.

[Structure 6]

As shown in FIG. 2, the structure 6 includes the plurality of rectangular pipes 60 joined by welding. The structure 6 is a single-piece member into which the plurality of metal rectangular pipes 60 are joined by welding.

It is noted that, in the example shown in FIG. 2, a metal panel 8 is welded to the structure 6.

In the description below, one of two rectangular pipes 60 in the structure 6 joined by welding is referred to as a first rectangular pipe 60a, and the other is referred to as a second rectangular pipe 60b (see FIG. 3). That is, the plurality of rectangular pipes 60 include the first rectangular pipe 60a and the second rectangular pipe 60b joined by welding.

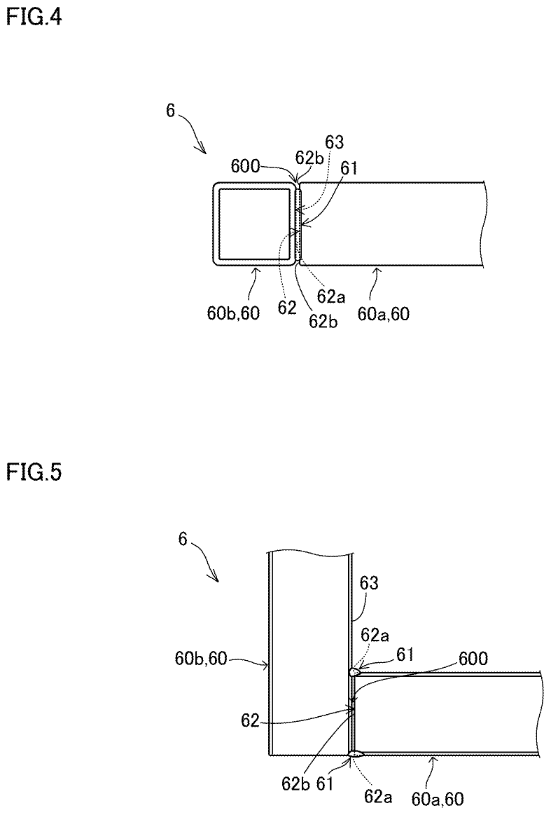

FIG. 3 is a perspective view of the first rectangular pipe 60a and the second rectangular pipe 60b. FIG. 4 is a side view of a joint part of the first rectangular pipe 60a and the second rectangular pipe 60b. FIG. 5 is a plan view of the joint part of the first rectangular pipe 60a and the second rectangular pipe 60b.

As shown in FIGS. 3 to 5, an end face 62 of the first rectangular pipe 60a is welded to a side face 63 of the second rectangular pipe 60b.

As shown in FIGS. 4 and 5, two parallel sides of four sides that constitute the end face 62 of the first rectangular pipe 60a are joint sides 62a welded to the side face 63 of the second rectangular pipe 60b.

That is, the joint sides 62a of the end face 62 of the first rectangular pipe 60a are joined to the side face 63 of the second rectangular pipe 60b by welds 61. The welds 61 are portions where the first rectangular pipe 60a and the second rectangular pipe 60b are partially fused.

The remaining two of the four sides that constitute the end face 62 of the first rectangular pipe 60a are non-joint sides 62b separated from the side face of the second rectangular pipe by a gap 600. It is noted that three of the four sides that constitute the end face 62 of the first rectangular pipe 60a may be the joint sides 62a and that the remaining one side may be the non-joint side 62b.

The joint sides 62a of the end face 62 are welded to the side face 63 of the second rectangular pipe 60b with the end face 62 of the first rectangular pipe 60a facing the side face of the second rectangular pipe 60b with the gap 600 therebetween.

Accordingly, variations in the dimensions of the end face 62 of the first rectangular pipe 60a do not affect the positional relationship between the first rectangular pipe 60a and the second rectangular pipe 60b.

[Method of Producing Structure 6]

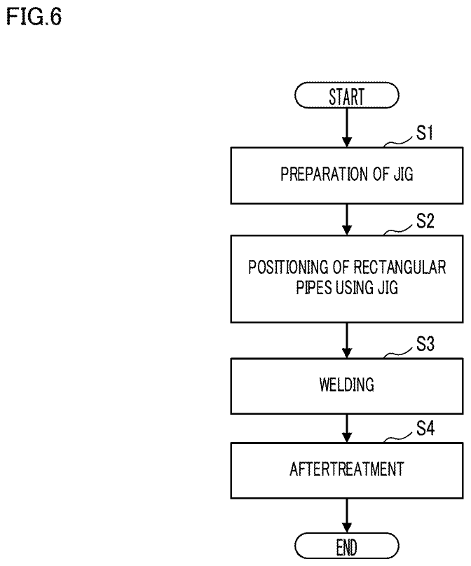

Next, a procedure of a method of producing the structure 6 will be described with reference to a flowchart shown in FIG. 6.

In the following description, S1, S2, . . . are identification signs representing a plurality of steps of the method of producing the structure 6.

<Step 1>

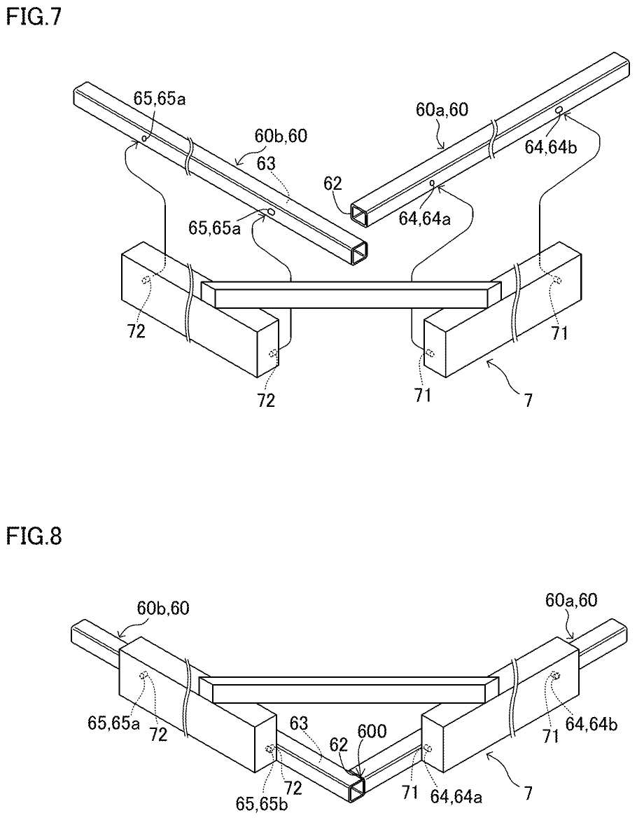

First, in step S1, a jig 7 used to position the plurality of rectangular pipes 60 is prepared (see FIGS. 7 and 8).

The jig 7 includes two first protrusions 71 corresponding to the first rectangular pipe 60a and two second protrusions 72 corresponding to the second rectangular pipe 60b.

The first rectangular pipe 60a has first holes 64 serving as two positioning holes into which the first protrusions 71 of the jig 7 are inserted. Similarly, the second rectangular pipe 60b has second holes 65 serving as two positioning holes into which the second protrusions 72 of the jig 7 are inserted.

That is, the first rectangular pipe 60a has the two first holes 64 corresponding to the two first protrusions 71 of the jig 7, and the second rectangular pipe 60b has the two second holes 65 corresponding to the two second protrusions 72 of the jig 7.

<Step S2>

Next, in step S2, the plurality of rectangular pipes 60 are disposed along the jig 7 to be positioned in a predetermined positional relationship.

Step S2 includes inserting the two first protrusions 71 of the jig 7 into the two first holes 64 of the first rectangular pipe 60a and inserting the two second protrusions 72 of the jig 7 into the two second holes 65 of the second rectangular pipe 60b.

In the present embodiment, one of the two first holes 64 in the first rectangular pipe 60a is a circular hole 64a, whereas the other is a long hole 64b extending in the longitudinal direction of the first rectangular pipe 60a. Similarly, one of the two second holes 65 in the second rectangular pipe 60b is a circular hole 65a, whereas the other is a long hole 65b extending in the longitudinal direction of the second rectangular pipe 60b.

Fitting one of the two first protrusions 71 in the circular hole 64a causes the first rectangular pipe 60a to be positioned in the longitudinal direction, and fitting the other of the two first protrusions 71 in the long hole 64b causes the first rectangular pipe 60a to be positioned in the lateral direction.

Similarly, fitting one of the two second protrusions 72 in the circular hole 65a causes the second rectangular pipe 60b to be positioned in the longitudinal direction, and fitting the other of the two second protrusions 72 in the long hole 65b causes the second rectangular pipe 60b to be positioned in the lateral direction.

In step S2, the first rectangular pipe 60a and the second rectangular pipe 60b are positioned in the predetermined positional relationship with the four sides that constitute the end face 62 of the first rectangular pipe 60a facing the side face 63 of the second rectangular pipe 60b with the gap 600 therebetween.

It is noted that step S2 is an example of positioning the first rectangular pipe 60a and the second rectangular pipe 60b.

<Step S3>

Next, in step S3, only two of the four sides that constitute the end face 62 of the first rectangular pipe 60a facing the side face 63 of the second rectangular pipe 60b with the gap 600 therebetween are welded to the side face 63 of the second rectangular pipe 60b.

In step S3, the welds 61 that join the joint sides 62a, which are some of the four sides that constitute the end face 62 of the first rectangular pipe 60a, and the side face 63 of the second rectangular pipe 60b are formed.

It is noted that, in step S3, only three of the four sides that constitute the end face 62 of the first rectangular pipe 60a may be welded to the side face 63 of the second rectangular pipe 60b.

As shown in steps S2 and S3, the protrusions 71 and 72 of the jig 7 are respectively inserted into the first holes 64 and the second holes 65 serving as the corresponding positioning holes when the first rectangular pipe 60a and the second rectangular pipe 60b are welded.

<Step S4>

Next, aftertreatment, such as deburring of the welds 61, is performed in step S4. This completes the production of the structure 6.

The structure 6 produced by the above-described production method does not cause variations in the dimensions of the end face 62 of the first rectangular pipe 60a to affect the positional relationship between the first rectangular pipe 60a and the second rectangular pipe 60b. As a result, the structure 6 can achieve high dimensional accuracy.

1. A structure comprising:
a plurality of rectangular pipes joined together, wherein
the plurality of rectangular pipes include a first rectangular pipe and a second rectangular pipe joined by welding, and
two or three of four sides that constitute an end face of the first rectangular pipe are joint sides welded to a side face of the second rectangular pipe, whereas a rest of the four sides is a non-joint side separated from the side face of the second rectangular pipe by a gap.

2. The structure according to claim 1, wherein
the first rectangular pipe and the second rectangular pipe each include two positioning holes in which protrusions of a jig for positioning are fitted when the first rectangular pipe and the second rectangular pipe are welded together.

3. The structure according to claim 2, wherein
one of the two positioning holes in each of the first rectangular pipe and the second rectangular pipe is a circular hole, whereas the other is a long hole extending in a longitudinal direction of each of the first rectangular pipe and the second rectangular pipe.

4. An image forming apparatus comprising:
a sheet feed portion;
a printing portion that forms an image on a sheet supplied from the sheet feed portion; and
the structure according to claim 1 that houses and supports the sheet feed portion and the printing portion.

5. A method of producing a structure including a plurality of rectangular pipes joined together, the method comprising:
positioning a first rectangular pipe and a second rectangular pipe by placing the first rectangular pipe and the second rectangular pipe along a jig for positioning such that four sides constituting an end face of the first rectangular pipe face a side face of the second rectangular pipe with a gap therebetween; and
welding only two or three of the four sides that constitute the end face of the first rectangular pipe, the four sides facing the side face of the second rectangular pipe with the gap therebetween, to the side face of the second rectangular pipe.

6. The method of producing the structure according to claim 5, wherein
the jig includes two first protrusions corresponding to the first rectangular pipe and two second protrusions corresponding to the second rectangular pipe,
the first rectangular pipe includes two first holes corresponding to the first protrusions, the second rectangular pipe includes two second holes corresponding to the second protrusions, and
the positioning the first rectangular pipe and the second rectangular pipe includes inserting the two first protrusions of the jig into the two first holes of the first rectangular pipe and inserting the two second protrusions of the jig into the two second holes of the second rectangular pipe.
